(19) United States
(12) Patent Application Publication
(10) Pub. No.: US 2025/0024855 A1
(43) Pub. Date: Jan. 23, 2025

(54) METHOD FOR RESHAPING WALNUT DREG-DERIVED FIBROUS TISSUE PROTEIN USING MULTI-STAGE TEMPERATURE-VARIABLE MODERATE EXTRUSION DEVICE IN CONJUNCTION WITH GREEN STABLE CROSS-LINKING CURING AGENT, AND USE THEREOF

(71) Applicant: Institute of Agro-Products Storage and Processing, Xinjiang Academy of Agricultural Sciences, Urumqi (CN)

(72) Inventors: Yan Ma, Urumqi (CN); Mingqiang Xu, Urumqi (CN); Jian Zhang, Urumqi (CN); Ting Zhang, Urumqi (CN); Xintao Meng, Urumqi (CN); Yan Pan, Urumqi (CN); Bin Xu, Urumqi (CN)

(73) Assignee: Institute of Agro-Products Storage and Processing, Xinjiang Academy of Agricultural Sciences, Urumqi (CN)

(21) Appl. No.: 18/414,307

(22) Filed: Jan. 16, 2024

(30) Foreign Application Priority Data
Jul. 19, 2023 (CN) 2023108936108

(51) Int. Cl. A23J 1/14; A23J 3/18; A23J 3/26; A23L 5/30; A23L 29/30; B29C 48/92

(52) U.S. Cl. CPC A23J 1/14; A23J 3/18; A23J 3/26; A23L 5/30; A23L 29/30; B29C 48/92; B29C 2948/92704

(57) ABSTRACT

Provided are a stable cross-linking curing agent, and a walnut dreg-derived fibrous tissue protein prepared by a multi-stage temperature-variable moderate extrusion device in conjunction with a green stable cross-linking curing agent. The stable cross-linking curing agent includes inulin, sodium carboxymethyl cellulose, a sea buckthorn dreg-derived polysaccharide, and a resistant dextrin. The walnut dreg-derived fibrous tissue protein includes a walnut dreg, a vital wheat gluten, and the stable cross-linking curing agent.

### CROSS REFERENCE TO RELATED APPLICATION

This application claims the benefit and priority of Chinese Patent Application No. 2023108936108, entitled “Method for reshaping walnut dreg-derived fibrous tissue protein using multi-stage temperature-variable moderate extrusion device in conjunction with green stable cross-linking curing agent, and use thereof” filed with the China National Intellectual Property Administration on Jul. 19, 2023, the disclosure of which is incorporated by reference herein in its entirety fully as part of the present application.

### TECHNICAL FIELD

The present disclosure belongs to the technical field of comprehensive utilization of agricultural and sideline products and plant proteins, and specifically relates to a method for reshaping a walnut dreg-derived fibrous tissue protein using a multi-stage temperature-variable moderate extrusion device in conjunction with a green stable cross-linking curing agent, and use thereof.

### BACKGROUND

Plant protein is an essential nutrient for human health, and it has become a trend to eat high-protein foods. Vegetarian meat products with plant-based protein as a main source could be used as the most suitable substitute for meat products due to the fact that they are green, energy-saving, environmental-friendly, healthy, and low-calorie, and play a positive role in food safety, nutrition and health, and ecological environment. In the next 5 to 10 years, the vegetarian meat products will show explosive growth and then become an important direction and key carrier of future food development, with broad development prospects. Fibrous tissue proteins from different plant sources have different conformations and different shaping effects. Currently, only soybean-, pea-, and peanut-derived proteins could be used, and the soybean-derived proteins have a peculiar smell and are not conducive to sales. As a result, there are extremely limited protein base sources that meet the requirements at present.

Walnut is a characteristic tree fruit, and its dreg after oil extraction is rich in proteins and amino acids, with a protein content of up to 54%. It could be used as a new resource of plant-based protein for preparing plant-based vegetarian meat, which could not only replace soybean protein source materials with peculiar smell, but also improve the utilization rate and additional value of walnut protein dreg. However, as a vegetarian meat source, it is difficult for a single walnut-based protein to form a desirable fibrous tissue structure, which must be basically formed by proportioning with a large proportion of vital wheat gluten (at least 30% of walnut protein dreg+70% of vital wheat gluten). This leads to the disadvantages of high cost and low utilization rate in producing the vegetarian meat protein from walnut dreg.

So far, a common solution is to add a protein cross-linking agent or glycosylation graft to the plant proteins. The protein cross-linking agent is protein glutamyl transaminase (TG enzyme) or glutaraldehyde; however, the TG enzyme is expensive while the glutaraldehyde shows certain safety risks. The glycosylated grafts generally used are high-starch and high-glucose substances such as maltodextrin and dextran, which are not good for human health and have unsatisfactory shaping effects, thereby hindering the widespread application of walnut dreg in the production of vegetarian meat protein.

### SUMMARY

The present disclosure aims to provide a method for reshaping a walnut dreg-derived fibrous tissue protein using a multi-stage temperature-variable moderate extrusion device in conjunction with a green stable cross-linking curing agent, and use thereof. The stable cross-linking curing agent according to the present disclosure is safe and can improve the sensory properties and texture of plant protein-based vegetarian meat. The walnut dreg-derived fibrosis tissue protein is used as a main base material of the artificial meat, with advantages of low cost, environmental friendliness, health, and safety.

To achieve the above object, the present disclosure provides the following technical solutions.

The present disclosure provides a stable cross-linking curing agent, including the following components in parts by mass: 0.5 parts to 1 part of inulin, 2 parts to 5 parts of sodium carboxymethyl cellulose, 0.5 parts to 3.5 parts of a sea buckthorn dreg-derived polysaccharide, and 0.5 parts to 1 part of a resistant dextrin; where the sea buckthorn dreg-derived polysaccharide is prepared by water extraction of a sea buckthorn dreg with the assistance of an electrostatic field.

In some embodiments, the sea buckthorn dreg-derived polysaccharide is prepared by a process including the following steps:
mixing a powder of the sea buckthorn dreg and water to obtain a mixture, and subjecting the mixture to the water extraction with the assistance of the electrostatic field to obtain a water extract; and
mixing the water extract and an ethanol solution to obtain a mixed solution, and subjecting the mixed solution to alcohol precipitation to obtain a reaction system, and subjecting the reaction system to solid-liquid separation to obtain the sea buckthorn dreg-derived polysaccharide;
where the electrostatic field has an electric field intensity of 10 kV to 50 kV, a pulse frequency of 10 Hz to 60 Hz, and a pulse time of 20 min to 60 min; and the water extraction is conducted at a material-to-liquid ratio of 1:(2-10) at a temperature of 30° C. to 50° C.

The present disclosure further provides a walnut dreg-derived fibrous tissue protein, which is prepared from raw materials comprising the following components by mass percentage:
60% to 80% of a walnut dreg, 10% to 30% of a vital wheat gluten, and 5% to 10% of a curing agent, the curing agent being the stable cross-linking curing agent as described in the above solutions.

The present disclosure further provides a method for preparing the walnut dreg-derived fibrous tissue protein as described in the above solutions, including the following steps:
mixing the walnut dreg, the vital wheat gluten, the curing agent, and water to obtain a paste; and
subjecting the paste to extrusion mixing, high-temperature melting, extrusion shaping in sequence to obtain a product, and cooling the product to obtain the walnut dreg-derived fibrous tissue protein.

In some embodiments, the paste has a moisture content of 40% to 60%.

In some embodiments, the extrusion mixing is conducted at a temperature of 35° C. to 65° C. and a pressure of 0.2 MPa to 0.45 MPa for 5 min to 10 min;
the high-temperature melting is conducted at a temperature of 80° C. to 100° C. and a pressure of 10 MPa to 40 MPa for 10 min to 20 min;
the extrusion shaping is conducted at a temperature of 105° C. to 155° C. and a pressure of 40 MPa to 50 MPa for 20 min to 30 min; and
the cooling is conducted at a temperature of 40° C. to 50° C. and an atmospheric pressure.

In some embodiments, the method as described in the above solutions further includes subjecting a cooled product obtain after the cooling to drying and sterilization in sequence to obtain the walnut dreg-derived fibrous tissue protein; where the drying is conducted at a temperature of 30° C. to 60° C.; and the sterilization is conducted by ultraviolet sterilization at a power of 30,000 μW/cm² to 35,000 μW/cm².

The present disclosure further provides use of the walnut dreg-derived fibrous tissue protein as described in the above solutions or the walnut dreg-derived fibrosis tissue protein prepared by the method as described in the above solutions in an artificial meat.

The present disclosure further provides a multi-stage temperature-variable extrusion device for the method for preparing the walnut dreg-derived fibrous tissue protein as described in the above solutions, including:
an extrusion barrel, where one end of the extrusion barrel is fixedly connected to an extrusion die head 8, and a feeding port is arranged on a barrel wall near the other end of the extrusion barrel; the extrusion barrel is divided into a feeding zone 4, an extrusion mixing zone 5, a high-temperature melting zone 6, and an extrusion shaping zone 7 along a direction from the feeding port to the extrusion die head 8; the feeding zone 4, the extrusion mixing zone 5, the high-temperature melting zone 6, and the extrusion shaping zone 7 are connected to a first water supply branch, a second water supply branch, a third water supply branch, and a fourth water supply branch, respectively; the barrel wall of the extrusion barrel is provided with a jacket layer, and an outer wall of the jacket layer is provided with a cooling water inlet and a cooling water outlet;
an extrusion screw 3 arranged inside the extrusion barrel, where the extrusion screw 3 is connected to an output shaft of a motor 1; and
a first heater 12, a second heater, a third heater, and a fourth heater that are configured to heat the feeding zone 4, the extrusion mixing zone 5, the high-temperature melting zone 6, and the extrusion shaping zone 7, respectively.

In some embodiments, the multi-stage temperature-variable extrusion device as described in the above solutions further includes:
a feeding hopper 2 fixedly connected to the feeding port;
a first temperature sensor, a second temperature sensor, a third temperature sensor, and a fourth temperature sensor that are configured to conduct temperature sensing on the feeding zone 4, the extrusion mixing zone 5, the high-temperature melting zone 6, and the extrusion shaping zone 7, respectively;
a controller 17 in signal communication with the first temperature sensor, the second temperature sensor, the third temperature sensor, the fourth temperature sensor, and the motor 1;
a wire control board 13 electrically connected to the first heater 12, the second heater, the third heater, and the fourth heater, where the wire control board 13 is in signal communication with the controller 17;
a transformer 14 electrically connected to the wire control board 13;
a water storage container 15, where the water storage container 15 is connected to the cooling water inlet through a first pipe 10 and connected to the cooling water outlet through a second pipe 11; the water storage container 15 is further connected with a water supply pipe 9; and the water supply pipe 9 is simultaneously connected to the first water supply branch, the second water supply branch, the third water supply branch, and the fourth water supply branch; and
a rack 18, where the extrusion barrel is fixedly arranged on the rack 18.

The present disclosure provides a stable cross-linking curing agent, including the following components in parts by mass: 0.5 parts to 1 part of inulin, 2 parts to 5 parts of sodium carboxymethyl cellulose, 0.5 parts to 3.5 parts of sea buckthorn dreg-derived polysaccharide, and 0.5 parts to 1 part of resistant dextrin; where the sea buckthorn dreg-derived polysaccharide is prepared by water extraction of a sea buckthorn dreg with the assistance of an electrostatic field. The stable cross-linking curing agent according to the present disclosure could enhance the plasticity of a protein fiber structure in the walnut dreg, and activate the peptide bonds, disulfide bonds, hydrogen bonds, and ionic bonds on protein molecules of the walnut dreg, causing changes in an interaction force between the protein molecules of the walnut dreg. As a result, under the action of the stable cross-linking curing agent, protein molecules of the walnut dreg undergo four processes of “stretching-agglomeration-aggregation-cross-linking” to form a “skeleton” of a fiber structure, and ultimately form a multidimensional fiber network structure under the interaction force between molecules.

The present disclosure further provides a walnut dreg-derived fibrous tissue protein, which is prepared from the following raw materials by mass percentage: 60% to 80% of a walnut dreg, 10% to 30% of a vital wheat gluten, and 5% to 10% of a curing agent; where the curing agent is the stable cross-linking curing agent as described in the above solutions. In the present disclosure, the stable cross-linking curing agent is added to increase a proportion of the walnut dreg to 60% to 80% and reduce a proportion of the vital wheat gluten to 15% to 30% in the raw materials, thus greatly reducing a production cost and improving a utilization rate of the walnut dreg. Further, the prepared walnut dreg-derived fibrous tissue protein shows excellent structural and functional properties. The results of examples show that the walnut dreg-derived fibrous tissue protein according to the present disclosure has a crude fat content of 1% to 5%, a texturization degree of 1.00 to 2.00, a hardness of 81.54 N to 150.17 N, a cohesive force of 0.61 to 0.85, an elasticity of 1.83 mm to 7.41 mm, an adhesiveness of 44.21 N to 117.70N, a chewiness of 119.27 mJ to 432.75 mJ, an oil holding capacity of 2.43 g/g to 5.25 g/g, a cholesterol absorption capacity (CAC) of 45.12% to 65.24%, a bile acid blocking index of 52.46% to 86.32%, and a pepsin digestion capacity of 38.46% to 45.76%. Accordingly, the walnut dreg-derived fibrous tissue protein according to the present disclosure exhibits desirable quality and could be used as a base material of green vegetarian meat products. It can not only replace the soybean protein source base material with peculiar smell, but also improve the utilization rate and additional value of walnut protein dreg.

### BRIEF DESCRIPTION OF THE DRAWINGS

FIG. 1 shows a schematic structural diagram of the multi-stage temperature-variable extrusion device according to an embodiment of the present disclosure; where

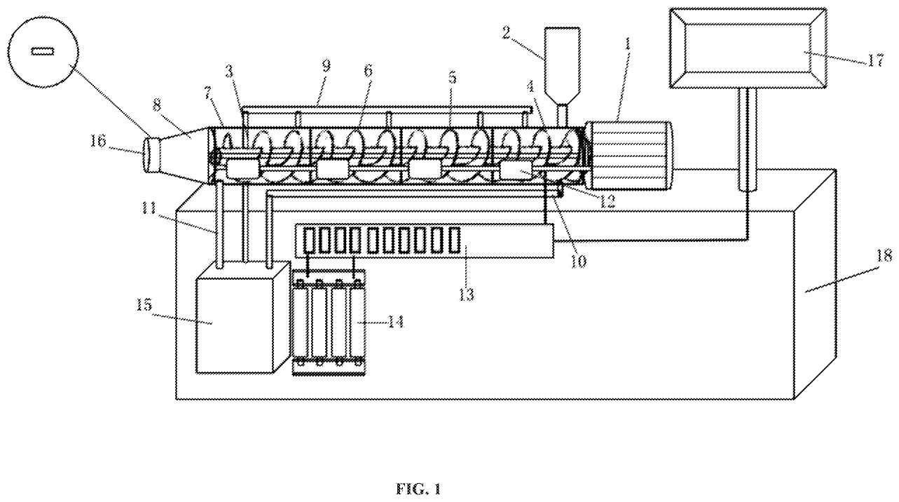

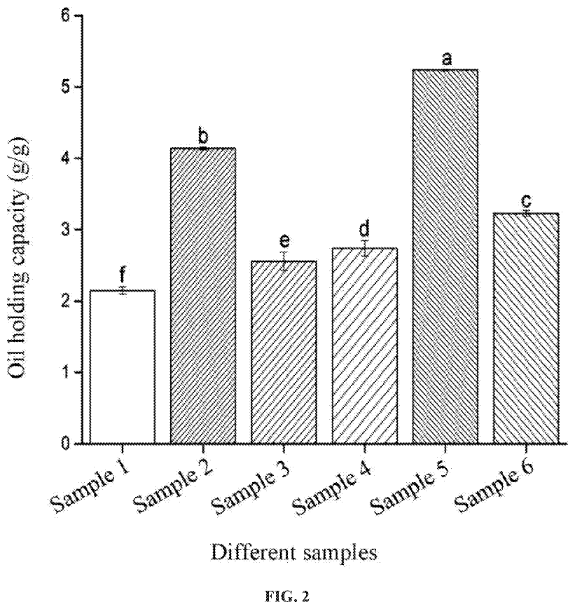

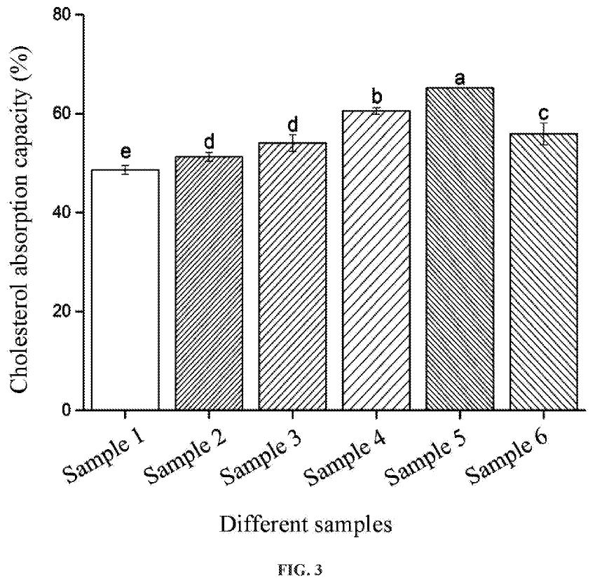

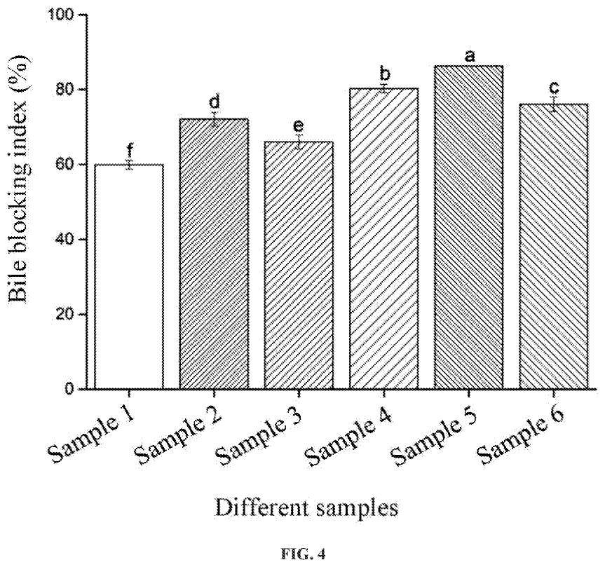

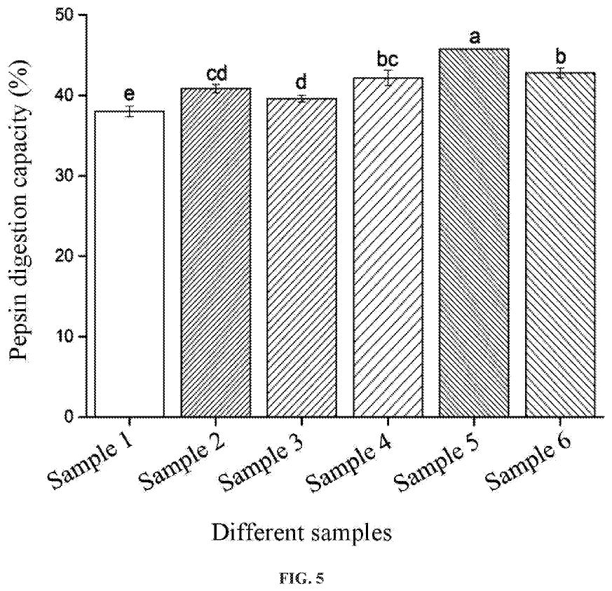

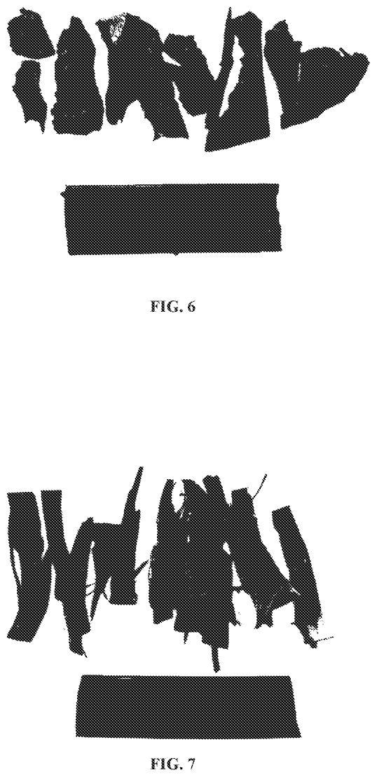

in FIG. 1, 1 represents a motor, 2 represents a feeding hopper, 3 represents a extrusion screw, 4 represents a feeding zone, 5 represents a extrusion mixing zone, 6 represents a high-temperature melting zone, 7 represents a extrusion shaping zone, 8 represents a extrusion die head, 9 represents a water supply pipe, 10 represents a first pipe, 11 represents a second pipe, 12 represents a first heater, 13 represents a wire control board, 14 represents a transformer, 15 represents a water storage container, 16 represents a extrusion shaping die orifice, 17 represents a controller, and 18 represents a rack.

FIG. 2 shows an influence of the products prepared in Examples 1 to 6 on an oil holdup.

FIG. 3 shows an influence of the products prepared in Examples 1 to 6 on a cholesterol absorption capacity.

FIG. 4 shows an influence of the products prepared in Examples 1 to 6 on a bile blocking index.

FIG. 5 shows an influence of the products prepared in Examples 1 to 6 on a pepsin digestion capacity.

FIG. 6 is a picture showing the product prepared in Example 4 according to the present disclosure.

FIG. 7 is a picture showing the product prepared in Example 5 according to the present disclosure.

### DETAILED DESCRIPTION OF THE EMBODIMENTS

The present disclosure provides a stable cross-linking curing agent, including (or consisting of) the following components in parts by mass: 0.5 parts to 1 part of inulin, 2 parts to 5 parts of sodium carboxymethyl cellulose, 0.5 parts to 3.5 parts of a sea buckthorn dreg-derived polysaccharide, and 0.5 parts to 1 part of a resistant dextrin; where the sea buckthorn dreg-derived polysaccharide is prepared by water extraction of a sea buckthorn dreg with the assistance of an electrostatic field.

In the present disclosure, unless otherwise specified, all raw materials/components for preparation are commercially available products well-known to those skilled in the art.

In some embodiments, the stable cross-linking curing agent includes 0.5 parts to 1 part, preferably 0.5 parts or 1 part of the inulin.

In the present disclosure, the inulin is purchased from Wuhan Guanying Biotechnology Co., Ltd., China, and has a mass content of 90.9%.

In some embodiments, the stable cross-linking curing agent includes 2 parts to 5 parts, preferably 2 parts, 3.5 parts, or 5 parts of the sodium carboxymethyl cellulose (CMC-Na) based on the parts by mass of the inulin.

In the present disclosure, the sodium carboxymethyl cellulose is purchased from Guangzhou Jingtang Biotechnology Co., Ltd., China, with a model number of FH9 and a content of 99.82 wt/%.

In the present disclosure, the stable cross-linking curing agent includes 0.5 parts to 3.5 parts, preferably 3 parts, 1.5 parts, 3.5 parts, or 0.5 parts of the sea buckthorn dreg-derived polysaccharide based on the parts by mass of the inulin.

In some embodiments, the sea buckthorn dreg-derived polysaccharide is prepared by a process including the following steps:
mixing a powder of the sea buckthorn dreg and water to obtain a mixture, and subjecting the mixture to the water extraction with the assistance of the electrostatic field to obtain a water extract; and
mixing the water extract and an ethanol solution to obtain a mixed solution, and subjecting the mixed solution to alcohol precipitation to obtain a reaction system, and subjecting the reaction system to solid-liquid separation to obtain the sea buckthorn dreg-derived polysaccharide;
where the electrostatic field has an electric field intensity of 10 kV to 50 kV, a pulse frequency of 10 Hz to 60 Hz, and a pulse time of 20 min to 60 min; and the water extraction is conducted at a material-to-liquid ratio of 1 g:(2-10) mL at a temperature of 30° C. to 50° C.

The powder of the sea buckthorn dreg and water is mixed and then subjected to the water extraction with the assistance of the electrostatic field to obtain a water extract. In some embodiments, before the mixing, the sea buckthorn dreg is subjected to a pretreatment. In some embodiments, the pretreatment is performed by subjecting the powder of the sea buckthorn dreg to pulverizing, drying, crushing, and sieving in sequence, where the drying is freeze-drying at a temperature of −40° C. for 18 h, and the sieving is performed by a filter sieve with a mesh opening of 60 mesh to 80 mesh. In some embodiments, the electrostatic field has an electric field intensity of 10 kV to 50 kV, preferably 15 kV to 45 kV, and more preferably 20 kV to 40 kV; the electrostatic field has a pulse frequency of 10 Hz to 60 Hz, preferably 15 Hz to 55 Hz, and more preferably 20 Hz to 50 Hz; and the electrostatic field has a pulse time of 20 min to 60 min, preferably 25 min to 50 min. In some embodiments, the water extraction is conducted at a material-to-liquid ratio of 1 g:(2-10) mL, preferably 1 g:(2.5-8) mL and the water extraction is conducted at a temperature of 30° C. to 50° C., preferably 35° C. to 45° C.

In some embodiments, after the water extraction is completed, a resulting water extraction liquid is subjected to concentration to obtain a supernatant as the water extract. The concentration is conducted by rotary evaporation, and the water extract has a volume of ½ of that of the resulting water extraction liquid.

After the water extract is obtained, it is mixed with an ethanol solution to obtain a mixed solution, and the mixed solution is subjected to alcohol precipitation to obtain a reaction system, and the reaction system is subjected to solid-liquid separation to obtain the sea buckthorn dreg-derived polysaccharide. In some embodiments, the ethanol solution is an ethanol-aqueous solution, and ethanol in the ethanol-aqueous solution has a volume percentage of 75% to 95%, preferably 75%. In some embodiments, a volume ratio of the water extract to the ethanol solution is 1:5. In some embodiments, the alcohol precipitation is conducted under standing conditions for 3 h. In some embodiments, the solid-liquid separation is conducted by suction filtration at 0.5 MPa to 0.8 MPa.

In some embodiments, the stable cross-linking curing agent includes 0.5 parts to 1 part, preferably 1 part or 0.5 parts of the resistant dextrin based on the parts by mass of the inulin.

In the present disclosure, the resistant dextrin belongs to a food-grade soluble dietary fiber, is purchased from Henan Junmao Biotechnology Co., Ltd., China, and has a mass content of 99%.

The stable cross-linking curing agent according to the present disclosure could reshape a fibrous tissue spatial network structure of the protein, thus further strengthening the formation of a better walnut dreg-derived fibrous tissue protein.

The present disclosure further provides a walnut dreg-derived fibrous tissue protein, which is prepared from raw materials comprising (or consisting of) the following components by mass percentage.

60% to 80% of a walnut dreg, 10% to 30% of a vital wheat gluten, and 5% to 10% of a curing agent, the curing agent being the stable cross-linking curing agent as described in the above solutions.

In some embodiments, the walnut dreg-derived fibrous tissue protein is prepared from raw materials including 60% to 80%, preferably 60%, 65%, 70%, 75%, or 80% of the walnut dreg by mass percentage.

In some embodiments, the walnut dreg has an initial protein content of 30% to 55% and a crude fat content of 1% to 5%. In some embodiments, the walnut dreg has a particle size of 80 mesh to 100 mesh, that is, the walnut dreg has a particle size that passes through an 80-mesh sieve and is left by a 100-mesh sieve.

In some embodiments, the walnut dreg-derived fibrous tissue protein is prepared from raw materials including 10% to 30%, preferably 30%, 25%, 20%, 10%, or 15% of the vital wheat gluten by mass percentage.

In some embodiments, the walnut dreg-derived fibrous tissue protein is prepared from raw materials including 5% to 10%, preferably 10% or 5% of the curing agent by mass percentage. The curing agent is the stable cross-linking curing agent as described in the above solutions.

In some specific embodiments of the present disclosure, the walnut dreg-derived fibrous tissue protein is prepared from raw materials, by mass percentage, consisting of: 60% of walnut dreg, 30% of vital wheat gluten, 0.5% of inulin, 5% of CMC-Na, 3.5% of sea buckthorn dreg-derived polysaccharide, and 1% of resistant dextrin; alternatively, 65% of walnut dreg, 25% vital wheat gluten, 1% of inulin, 5% of CMC-Na, 3% of sea buckthorn dreg-derived polysaccharide, and 1% of resistant dextrin; alternatively, 70% of walnut dreg, 25% of vital wheat gluten, 1% of inulin, 2% of CMC-Na, 1.5% of sea buckthorn dreg-derived polysaccharide, and 0.5% of resistant dextrin; alternatively, 75% of walnut dreg, 20% of vital wheat gluten, 0.5% of inulin, 3.5% of CMC-Na, 0.5% of sea buckthorn dreg-derived polysaccharide, and 0.5% of resistant dextrin; alternatively, 80% of walnut dreg, 10% of vital wheat gluten, 1% of inulin, 5% of CMC-Na, 3.5% of sea buckthorn dreg-derived polysaccharide, and 0.5% of resistant dextrin; alternatively, 80% of walnut dreg, 15% of vital wheat gluten, 1% of inulin, 2% of CMC-Na, 2% of sea buckthorn dreg-derived polysaccharide, and 1% of resistant dextrin.

The walnut dreg-derived fibrous tissue protein according to the present disclosure has a crude fat content of 1% to 5%, a texturization degree of 1.00 to 2.00, a hardness of 81.54 N to 150.17 N, a cohesive force of 0.61 to 0.85, an elasticity of 1.83 mm to 7.41 mm, an adhesiveness of 44.21 N to 117.70 N, a chewiness of 119.27 mJ to 432.75 mJ, an oil holding capacity of 2.43 g/g to 5.25 g/g, a cholesterol absorption capacity (CAC) of 45.12% to 65.24%, a bile acid blocking index of 52.46% to 86.32%, and a pepsin digestion capacity of 38.46% to 45.76%; and the walnut dreg-derived fibrous tissue protein has a moisture content of 12.5% to 15.5%.

The present disclosure further provides a method for preparing the walnut dreg-derived fibrous tissue protein as described in the above solutions, including (or consisting of) the following steps:
mixing the walnut dreg, the vital wheat gluten, and the curing agent and water to obtain a paste; and
subjecting the paste to extrusion mixing, high-temperature melting, extrusion shaping in sequence to obtain a product, and cooling the product to obtain the walnut dreg-derived fibrous tissue protein.

The walnut dreg, the vital wheat gluten, and the curing agent are mixed with water to obtain a paste.

In some embodiments, the mixing is conducted at a temperature of 25° C. to 50° C.; the mixing is conducted in the feeding zone of the extrusion barrel of a screw device with a rotational speed of an extrusion screw in the extrusion barrel of 5 r/min to 10 r/min, preferably 8 r/min to 12 r/min; and the mixing is conducted for 20 s to 40 s.

In some embodiments, the paste has a moisture content of 40% to 60%, preferably 45% to 55%.

The paste is subjected to extrusion mixing, high-temperature melting, extrusion shaping in sequence to obtain a product, and then the product is cooled to obtain the walnut dreg-derived fibrous tissue protein.

In some embodiments, the extrusion mixing, the high-temperature melting, and the extrusion shaping are conducted in the extrusion barrel of the screw device.

In some embodiments, the extrusion mixing is conducted in an extrusion mixing zone of the extrusion barrel. In some embodiments, the extrusion mixing is conducted at a temperature of 35° C. to 65° C., preferably 40° C. to 60° C.; the extrusion mixing is conducted at a pressure of 0.2 MPa to 0.45 MPa, preferably 0.25 MPa to 0.4 MPa; and the extrusion mixing is conducted for 5 min to 10 min.

In some embodiments, a resulting material after the extrusion mixing is transferred to a high-temperature melting zone of the extrusion barrel of the screw device and then subjected to the high-temperature melting. In some embodiments, the high-temperature melting is conducted at a temperature of 80° C. to 100° C., preferably 85° C. to 95° C.; the high-temperature melting is conducted at a pressure of 10 MPa to 40 MPa, preferably 15 MPa to 35 MPa; and the high-temperature melting is conducted for 10 min to 20 min.

In some embodiments, a material obtained after the high-temperature melting is transferred to an extrusion shaping zone of the extrusion barrel of the screw device and then subjected to the extrusion shaping. In some embodiments, the extrusion shaping is conducted at a temperature of 105° C. to 155° C., preferably 110° C. to 150° C.; the extrusion shaping is conducted at a pressure of 40 MPa to 50 MPa, preferably 42 MPa to 46 MPa; and the extrusion shaping is conducted for 20 min to 30 min.

In the present disclosure, the paste is sequentially subjected to extrusion mixing, high-temperature melting and extrusion shaping under the above operating parameters, which could effectively ensure that the green stable cross-linking curing agent could improve a plasticity of the fiber tissue structure in the walnut dreg protein after the walnut dreg protein and the green stable cross-linking curing agent are mixed. During the extrusion mixing, high-temperature melting, and extrusion shaping, molecular forces such as peptide bonds, disulfide bonds, hydrogen bonds, and ionic bonds between protons of the walnut dreg protein are changed by dual physical and chemical effects of the green stable cross-linking curing agent and physical extrusion. In this way, the structure of the walnut dreg protein undergoes four processes of “stretching, agglomeration, aggregation, and cross-linking” to form the “skeleton” of a fiber structure, and finally forms a multidimensional fiber network structure under the interaction force between molecules.

In some embodiments, a material obtained after the extrusion shaping is transferred to an extrusion die head and cooled, and then discharged from an extrusion shaping die orifice of the extrusion die head.

In some embodiments, the cooling is performed by transporting the material obtained after the extrusion shaping to the extrusion die head fixedly connected to the extrusion barrel of the screw device, lowering the temperature of the material in the extrusion die head to obtain a cooled product, and then extruding the cooled product through the extrusion shaping die orifice of the extrusion die head.

In some embodiments, the cooling is conducted at a temperature of 40° C. to 50° C., preferably 42° C. to 45° C., and the cooling is conducted at atmospheric pressure.

In some embodiments, a cooled product obtained after the cooling is further subjected to drying and sterilization in sequence to obtain the walnut dreg-derived fibrous tissue protein; the drying is conducted at a temperature of 30° C. to 60° C., preferably 40° C. to 50° C., and the drying is conducted for 30 min to 50 min; and the sterilization is an ultraviolet sterilization at a power of 30,000 μW/cm² to 35,000 μW/cm².

The present disclosure further provides use of the walnut dreg-derived fibrous tissue protein as described in the above solutions or the walnut dreg-derived fibrosis tissue protein prepared by the method as described in the above solutions in an artificial meat.

As shown in FIG. 1, the present disclosure further provides a multi-stage temperature-variable extrusion device for the method for preparing the walnut dreg-derived fibrous tissue protein according to an embodiment of the present disclosure. In an embodiment, the method for preparing the walnut dreg-derived fibrous tissue protein is conducted by using the multi-stage temperature-variable extrusion device shown in FIG. 1. The multi-stage temperature-variable extrusion device will be described in detail below with reference to FIG. 1.

In some embodiments, the multi-stage temperature-variable extrusion device includes an extrusion barrel, where one end of the extrusion barrel is fixedly connected to an extrusion die head 8, and a feeding port is arranged on a barrel wall near the other end of the extrusion barrel; the extrusion barrel is divided into a feeding zone 4, an extrusion mixing zone 5, a high-temperature melting zone 6, and an extrusion shaping zone 7 along a direction from the feeding port to the extrusion die head 8; the feeding zone 4, the extrusion mixing zone 5, the high-temperature melting zone 6, and the extrusion shaping zone 7 are respectively connected to a first water supply branch, a second water supply branch, a third water supply branch, and a fourth water supply branch; the barrel wall of the extrusion barrel is provided with a jacket layer, and an outer wall of the jacket layer is provided with a cooling water inlet and a cooling water outlet. The feeding zone 4 is provided for mixing the walnut dreg, the vital wheat gluten, and the curing agent and water to obtain the paste. The first water supply branch is configured to transport water into the feeding zone 4. The second water supply branch, the third water supply branch, and the fourth water supply branch are configured to respectively transport water to materials in the extrusion mixing zone 5, the high-temperature melting zone 6, and the extrusion shaping zone 7, thereby maintaining the moisture contents of the materials in the extrusion mixing zone 5, the high-temperature melting zone 6, and the extrusion shaping zone 7 in a range of 40% to 60%. The jacket layer is provided with a circulating cooling water flowing through therein for adjusting a temperature of the materials in the feeding zone 4, the extrusion mixing zone 5, the high-temperature melting zone 6, and the extrusion shaping zone 7.

In some embodiments, the multi-stage temperature-variable extrusion device further includes: a feeding hopper 2 fixedly connected to the feeding port. The feeding hopper 2 is configured to feed the raw materials into the feeding zone 4 of the extrusion barrel through the feeding port.

In some embodiments, the multi-stage temperature-variable extrusion device further includes an extrusion screw 3 arranged inside the extrusion barrel, where the extrusion screw 3 is fixedly connected to an output shaft of a motor 1.

In some embodiments, the extrusion screw 3 is a single extrusion screw or a double extrusion screw. In some embodiments, the motor 1 is configured to control the operation and speed of the extrusion screw 3. The extrusion screw 3 is configured to transport the paste from the feeding zone 4 to the extrusion mixing zone 5, the high-temperature melting zone 6, and the extrusion shaping zone 7 in sequence.

In some embodiments, the multi-stage temperature-variable extrusion device further includes: a first heater 12, a second heater, a third heater, and a fourth heater that are configured to heat the feeding zone 4, the extrusion mixing zone 5, the high-temperature melting zone 6, and the extrusion shaping zone 7, respectively.

In some embodiments, the multi-stage temperature-variable extrusion device further includes: a first temperature sensor, a second temperature sensor, a third temperature sensor, and a fourth temperature sensor that are configured to conduct temperature sensing on the feeding zone 4, the extrusion mixing zone 5, the high-temperature melting zone 6, and the extrusion shaping zone 7, respectively.

In some embodiments, the multi-stage temperature-variable extrusion device further includes: a controller 17 in signal communication with the first temperature sensor, the second temperature sensor, the third temperature sensor, the fourth temperature sensor, and the motor 1. The controller 17 is configured to control the operation and speed of the motor 1. The controller 17 is configured to simultaneously receive temperature signals from the first temperature sensor, the second temperature sensor, the third temperature sensor, and the fourth temperature sensor, and control operations of the first heater 12, the second heater, the third heater, and the fourth heater.

In a specific embodiment of the present disclosure, the controller 17 is a programmable logic controller (PLC).

In some embodiments, the multi-stage temperature-variable extrusion device further includes: a wire control board 13 electrically connected to the first heater 12, the second heater, the third heater, and the fourth heater, where the wire control board 13 is in signal communication with the controller 17.

In some embodiments, the multi-stage temperature-variable extrusion device further includes: a transformer 14 electrically connected to the wire control board 13. The transformer 14 energizes the first heater 12, the second heater, the third heater, and the fourth heater through the wire control board 13, thereby controlling the operations of the first heater 12, the second heater, the third heater, and the fourth heater.

In some embodiments, the multi-stage temperature-variable extrusion device further includes: a water storage container 15, where the water storage container 15 is connected to the cooling water inlet through a first pipe 10 and connected to the cooling water outlet through a second pipe 11; the water storage container 15 is further connected with a water supply pipe 9; and the water supply pipe 9 is simultaneously connected to the first water supply branch, the second water supply branch, the third water supply branch, and the fourth water supply branch.

In a specific embodiment of the present disclosure, the cooling water inlet is arranged on an outer wall of the jacket layer at a same end as the feeding port.

In a specific embodiment of the present disclosure, the cooling water outlet is arranged on the outer wall of the jacket layer close to one end of the extrusion die head 8.

In a specific embodiment of the present disclosure, an extrusion molding die orifice 16 is provided at an extrusion outlet of the extrusion die head 8.

In some embodiments, the multi-stage temperature-variable extrusion device further includes: a rack 18, where the extrusion barrel is fixedly arranged on the rack 18.

The multi-stage temperature-variable extrusion device according to the present disclosure has advantages of a high degree of continuity and high production efficiency, and shows benefits of “energy saving and high efficiency” compared with traditional screw extrusion device. The multi-stage temperature-variable extrusion device saves 50% energy compared with traditional single or double screw extrusion device, and could also achieve precise processing throughout the entire process, saving 25% labor force. Through the combined action of the stable cross-linking curing agent and the multi-stage temperature-variable extrusion device, the temperature and pressure of the feeding zone 4, the extrusion mixing zone 5, the high-temperature melting zone 6, and the extrusion shaping zone 7 in the extrusion barrel could be precisely controlled, thereby effectively reshaping the spatial network structure of protein fiber tissue. As a result, the protein fiber tissue is strengthened to form a better walnut dreg-derived fibrous tissue protein, which, as a main base material of artificial meat, is green, healthy, and safe, and could be widely used in the field of prepared food or snack food.

Walnut dreg is rich in nutrients, but has a low comprehensive utilization rate and is mostly sold at a low price as feed. However, Walnut dreg has a high protein content (30% to 55%), it thus could not only replace the soybean protein source base material with peculiar smell, but also improve the utilization rate and additional value of walnut protein dreg, thereby becoming a new resource of plant proteins. A single walnut dreg protein structure cannot form a better fibrous tissue structure. In order to reshape the spatial network structure of protein fiber tissue, a green stable cross-linking curing agent is developed that is safe and could improve the sensory properties and texture of plant protein-based vegetarian meat. Moreover, the stable cross-linking curing agent works synergistically with a multi-effect extrusion equipment to strengthen and form a better walnut dreg-derived fibrous tissue protein. As the main base material of artificial meat, the walnut dreg-derived fibrous tissue protein shows greenness, health, and safety. In addition to being suitable for walnut dreg, the walnut dreg-derived fibrous tissue protein could also be widely used in the field of prepared food or snack food.

In order to further illustrate the present disclosure, the technical solutions according to the present disclosure are described in detail below in conjunction with examples, but these examples should not be understood as limiting the scope of the present disclosure.

### Example 1

A process for preparing a sea buckthorn dreg-derived polysaccharide was performed as follow: a sea buckthorn dreg was crushed, freeze-dried at a temperature of −40° C. for 18 h. and then sieved through a 60 mesh to 80 mesh sieve to obtain a freeze-dried powder of the sea buckthorn dreg. 100 g of the freeze-dried powder of the sea buckthorn dreg and water were mixed to obtain a mixture, and the mixture was subjected to water extraction at 50° C. with a material-to-liquid ratio of 1 g:5 mL with the assistance of a high-voltage electrostatic field at an electric field strength of 50 kV and a pulse frequency of 60 Hz for 60 min. After the water extraction was completed, a resulting water extraction liquid was subjected to rotary evaporation to obtain a concentrate (with a volume of ½ of that of the resulting water extraction liquid); the concentrate and an ethanol-aqueous solution (with an ethanol volume content of 75%) were mixed in a volume ratio of 1:2 and then subjected to alcohol precipitation for 3 h to obtain a reaction product. The reaction product was subjected to suction filtration (at 0.8 MPa) to obtain a solid product, and the solid product was dried to obtain the sea buckthorn dreg-derived polysaccharide with a mass content of 40 wt %.

A walnut dreg which was obtained after extracting walnut oil from walnut by low-temperature pre-pressing and pressure extraction was ground to a particle size of 80 mesh to 100 mesh by a low-temperature ultrafine grinding machine.

A walnut dreg-derived fibrous tissue protein product was produced by using a multi-stage temperature-variable extrusion device shown in FIG. 1. 60% of the walnut dreg, 30% of vital wheat gluten, and 10% of a stable cross-linking curing agent (consisting of 0.5% of inulin, 5% of CMC-Na, 3.5% of the sea buckthorn dreg-derived polysaccharide, and 1% of resistant dextrin) were fed into a feeding hopper 2, and entered a feeding zone 4 through the feeding port. Water was added to the raw materials in the feed zone 4 through a first water supply branch and then mixed at 25° C. for 40 s, so as to obtain a paste with a moisture content of 40%. After that, temperatures of a first heater 12, a second heater, a third heater and a fourth heater, as well as speed and time of a motor 1 were adjusted and set by operating a controller PLC 17; and the paste with a moisture content of 40% was then transferred through a single extrusion screw 3 sequentially to; an extrusion mixing zone 5 where extrusion mixing was conducted at a temperature of 65° C. and a pressure of 0.45 MPa for 10 min, a high-temperature melting zone 6 where high-temperature melting was conducted at a temperature of 100° C. and a pressure of 40 MPa for 20 min; and an extrusion shaping zone 7 where extrusion shaping was conducted at a temperature of 150° C. and a pressure of 50 MPa for 30 min. After that, a resulting material was sent to an extrusion die head 8, then cooled to 50° C., and the pressure was recovered to 0.1 MPa, and a resulting product was extruded through an extrusion shaping die orifice 16 and then cooled to obtain a cooled material with a better fibrous structure.

The cooled material was subjected to drying (at 60° C.) in a fluidized bed and sterilization by ultraviolet (at 30,000 μW/cm²) to obtain the walnut dreg-derived fibrous tissue protein with a moisture content of 15%.

The walnut dreg-derived fibrous tissue protein with a moisture content of 15% was packaged and refrigerated (at 4° C.) to obtain a commercialized rehydratable walnut-based protein vegetarian meat with a fibrous tissue structure.

### Example 2

This example was conducted similar to Example 1, except that a walnut dreg-derived fibrous tissue protein product was prepared by using the multi-stage temperature-variable extrusion device shown in FIG. 1; 65% of the walnut dreg, 25% of the vital wheat gluten, and 10% of a stable cross-linking curing agent (consisting of 1% of the inulin, 5% of the CMC-Na, 3% of the sea buckthorn dreg-derived polysaccharide, and 1% of the resistant dextrin) were fed into the feeding hopper 2 to obtain the walnut dreg-derived fibrous tissue protein with a moisture content of 15%.

### Example 3

This example was conducted similar to Example 1, except that a walnut dreg-derived fibrous tissue protein product was prepared by using the multi-stage temperature-variable extrusion device shown in FIG. 1; 70% of the walnut dreg, 25% of the vital wheat gluten, and 5% of a stable cross-linking curing agent (consisting of 1% of the inulin, 2% of the CMC-Na, 1.5% of the sea buckthorn dreg-derived polysaccharide, and 0.5% of the resistant dextrin) were fed into the feeding hopper 2.

### Example 4

This example was conducted similar to Example 1, except that a walnut dreg-derived fibrous tissue protein product was prepared by using the multi-stage temperature-variable extrusion device shown in FIG. 1; 75% of the walnut dreg, 20% of the vital wheat gluten, and 5% of a stable cross-linking curing agent (consisting of 0.5% of the inulin, 3.5% of the CMC-Na, 0.5% of the sea buckthorn dreg-derived polysaccharide, and 0.5% of the resistant dextrin) were fed into the feeding hopper 2, and a picture showing the product was shown in FIG. 6.

### Example 5

This example was conducted similar to Example 1, except that a walnut dreg-derived fibrous tissue protein product was prepared by using the multi-stage temperature-variable extrusion device shown in FIG. 1; 80% of the walnut dreg, 10% of the vital wheat gluten, and 10% of a stable cross-linking curing agent (consisting of 1% of the inulin, 5% of the CMC-Na, 3.5% of the sea buckthorn dreg-derived polysaccharide, and 0.5% of the resistant dextrin) were fed into the feeding hopper 2, and a picture showing the product was shown in FIG. 7.

### Example 6

This example was conducted similar to Example 1, except that a walnut dreg-derived fibrous tissue protein product was prepared by using the multi-stage temperature-variable extrusion device shown in FIG. 1; 80% of the walnut dreg, 15% of the vital wheat gluten, and 5% of a self-made green stable cross-linking curing agent (consisting of 1% of the inulin, 2% of the CMC-Na, 2% of the sea buckthorn dreg-derived polysaccharide, and 1% of the resistant dextrin) were fed into the feeding hopper 2.

### Test Example

Reshaping effects of the walnut dreg-derived fibrous tissue protein prepared in Examples 1 to 6 are shown in Table 1 and FIG. 2 to FIG. 5, where Samples 1 to 6 in FIG. 2 to FIG. 5 corresponded to the product prepared in Examples 1 to 6, respectively.

TABLE 1
Comparison of color, moisture content before drying, and texture of product prepared in Examples 1 to 6

| | | | | Moisture | Texture | | | | | |
|---|---|---|---|---|---|---|---|---|---|---|
| | Color | | | content | Hardness | | Elasticity | Adhesiveness | Chewiness | Texturization |
| Sample | L | a | b | (%) | (N) | Cohesion | (mm) | (mJ) | (N) | degree |
| Example 1 | 22.53 ± | 8.1 ± | 22.96 ± | 57.42 ± | 124.34 ± | 0.61 ± | 3.91 ± | 97.36 ± | 380.76 ± | 1.86 ± |
| | 0.70a | 0.66d | 1.6c | 0.83a | 2.4c | 0.06c | 0.26b | 2.01b | 8.09c | 0.06b |
| Example 2 | 18.6 ± | 7.7 ± | 24 ± | 56.76 ± | 117.27 ± | 0.71 ± | 4.21 ± | 99.19 ± | 418.67 ± | 1.48 ± |
| | 0.28b | 0.35d | 1.56bc | 0.04a | 1.4d | 0.13abc | 0.49b | 4.99b | 7.02b | 0.03d |
| Example 3 | 19.44 ± | 10.03 ± | 27.13 ± | 50.93 ± | 150.17 ± | 0.67 ± | 3.6 ± | 117.70 ± | 432.75 ± | 1.53 ± |
| | 0.53b | 0.91c | 1.23ab | 1.18b | 2.70b | 0.06bc | 0.51b | 2.97a | 1.28a | 0.05d |
| Example 4 | 18.88 ± | 14.1 ± | 26.13 ± | 49.89 ± | 164.93 ± | 0.69 ± | 4.13 ± | 117.57 ± | 381.96 ± | 1.420 ± |
| | 0.81b | 0.59a | 2.71ab | 1.45b | 3.54a | 0.06abc | 0.2b | 2.75a | 7.85c | 0.10d |
| Example 5 | 14.96 ± | 11.9 ± | 27.65 ± | 46.49 ± | 90.04 ± | 0.79 ± | 6.89 ± | 75.73 ± | 306.25 ± | 2.00 ± |
| | 0.81d | 0.91b | 0.92a | 1.51c | 5.21f | 0.05ab | 0.74a | 3.85c | 1.85e | 0.08a |
| Example 6 | 16.23 ± | 13.6 ± | 28.3 ± | 44.67 ± | 78.08 ± | 0.82 ± | 7.41 ± | 66.14 ± | 363.62 ± | 1.74 ± |
| | 0.85c | 0.33a | 1.2a | 0.94c | 1.20g | 0.01a | 0.15a | 1.25d | 2.74d | 0.03c |

### Comparative Example 1

In this comparative example, a walnut dreg-derived fibrous tissue protein product was prepared by using the multi-stage temperature-variable extrusion device shown in FIG. 1; 60% of the walnut dreg and 40% of the vital wheat gluten were fed into the feeding hopper 2, a resulting walnut dreg-derived fibrous tissue protein could not be shaped.

### Comparative Example 2

In this comparative example, a walnut dreg-derived fibrous tissue protein product was prepared by using the multi-stage temperature-variable extrusion device shown in FIG. 1; 30% of the walnut dreg and 70% of the vital wheat gluten were fed into the feeding hopper 2, a resulting walnut dreg-derived fibrous tissue protein could be shaped. However, this process has high production costs and a low utilization rate of the walnut dreg.

### Comparative Example 3

In this comparative example, a walnut dreg-derived fibrous tissue protein product was prepared by using the multi-stage temperature-variable extrusion device shown in FIG. 1; 20% of the walnut dreg and 80% of the vital wheat gluten were fed into the feeding hopper 2 to obtain a fiber protein product with a texture of: a texturization degree of 0.85, a hardness of 80.13 N, cohesion force of 0.56, an elasticity of 3.11 mm, an adhesiveness of 83.79, and a chewiness of 124.47 mJ and with a functional properties of: an oil holding capacity of 2.2 g/g, a cholesterol absorption capacity of 35.12%, a bile blocking index of 41.35%, and a pepsin digestion capacity of 24.68%.

From the results of Example 1 and Comparative Example 3, it can be seen that the method for reshaping a fibrous tissue structure of a walnut dreg protein by controllable continuous temperature-variable moderate extrusion and green stable cross-linking curing agent has a better shaping effect. The product obtained by the method has desirable color, texture, and functional properties (oil holding capacity, cholesterol absorption capacity, bile acid blocking index, and pepsin digestion capacity), thereby exhibiting desirable application prospects.

Although the present disclosure is described in detail in conjunction with the foregoing embodiments, they are only a part of, not all of, the embodiments of the present disclosure. Other embodiments could be obtained based on these embodiments without creative efforts, which shall fall within the scope of the present disclosure.

What is claimed is:

1. A stable cross-linking curing agent, comprising the following components in parts by mass: 0.5 parts to 1 part of inulin, 2 parts to 5 parts of sodium carboxymethyl cellulose, 0.5 parts to 3.5 parts of a sea buckthorn dreg-derived polysaccharide, and 0.5 parts to 1 part of a resistant dextrin;
wherein the sea buckthorn dreg-derived polysaccharide is prepared by water extraction of a sea buckthorn dreg with the assistance of an electrostatic field.

2. The stable cross-linking curing agent of claim 1, wherein the sea buckthorn dreg-derived polysaccharide is prepared by a process comprising the following steps:
mixing a powder of the sea buckthorn dreg and water to obtain a mixture, and subjecting the mixture to the water extraction with the assistance of the electrostatic field to obtain a water extract; and
mixing the water extract and an ethanol solution to obtain a mixed solution, subjecting the mixed solution to alcohol precipitation to obtain a reaction system, and subjecting the reaction system to solid-liquid separation to obtain the sea buckthorn dreg-derived polysaccharide;
wherein the electrostatic field has an electric field intensity of 10 kV to 50 kV, a pulse frequency of 10 Hz to 60 Hz, and a pulse time of 20 min to 60 min; and the water extraction is conducted at a material-to-liquid ratio of 1:(2-10) at a temperature of 30° C. to 50° C.

3. A walnut dreg-derived fibrous tissue protein, which is prepared from raw materials comprising the following components by mass percentage: 60% to 80% of a walnut dreg, 10% to 30% of a vital wheat gluten, and 5% to 10% of a curing agent, the curing agent being the stable cross-linking curing agent of claim 1.

4. A method for preparing the walnut dreg-derived fibrous tissue protein of claim 3, comprising the following steps:
mixing the walnut dreg, the vital wheat gluten, the curing agent and water to obtain a paste; and
subjecting the paste to extrusion mixing, high-temperature melting, extrusion shaping in sequence to obtain a product, and cooling the product to obtain the walnut dreg-derived fibrous tissue protein.

5. The method of claim 4, wherein the paste has a moisture content of 40% to 60%.

6. The method of claim 4, wherein the extrusion mixing is conducted at a temperature of 35° C. to 65° C. and a pressure of 0.2 MPa to 0.45 MPa for 5 min to 10 min;
the high-temperature melting is conducted at a temperature of 80° C. to 100° C. and a pressure of 10 MPa to 40 MPa for 10 min to 20 min;
the extrusion shaping is conducted at a temperature of 105° C. to 155° C. and a pressure of 40 MPa to 50 MPa for 20 min to 30 min; and
the cooling is conducted at a temperature of 40° C. to 50° C. and an atmospheric pressure.

7. The method of claim 4, further comprising subjecting a cooled product obtained after the cooling to drying and sterilization in sequence to obtain the walnut dreg-derived fibrous tissue protein;
wherein the drying is conducted at a temperature of 30° C. to 60° C.; and
the sterilization is conducted by ultraviolet sterilization at a power of 30,000 μW/cm² to 35,000 μW/cm².

8. A method for preparing an artificial meat, comprising using the walnut dreg-derived fibrous tissue protein of claim 3.

9. A multi-stage temperature-variable extrusion device for the method for preparing the walnut dreg-derived fibrous tissue protein of claim 4, comprising:
an extrusion barrel, wherein one end of the extrusion barrel is fixedly connected to an extrusion die head (8), and a feeding port is arranged on a barrel wall near the other end of the extrusion barrel; the extrusion barrel is divided into a feeding zone (4), an extrusion mixing zone (5), a high-temperature melting zone (6), and an extrusion shaping zone (7) along a direction from the feeding port to the extrusion die head (8); the feeding zone (4), the extrusion mixing zone (5), the high-temperature melting zone (6), and the extrusion shaping zone (7) are connected to a first water supply branch, a second water supply branch, a third water supply branch, and a fourth water supply branch, respectively; the barrel wall of the extrusion barrel is provided with a jacket layer, and an outer wall of the jacket layer is provided with a cooling water inlet and a cooling water outlet;
an extrusion screw (3) arranged inside the extrusion barrel, wherein the extrusion screw (3) is connected to an output shaft of a motor (1); and
a first heater (12), a second heater, a third heater, and a fourth heater that are configured to heat the feeding zone (4), the extrusion mixing zone (5), the high-temperature melting zone (6), and the extrusion shaping zone (7), respectively.

10. The multi-stage temperature-variable extrusion device of claim 9, further comprising:
a feeding hopper (2) fixedly connected to the feeding port;
a first temperature sensor, a second temperature sensor, a third temperature sensor, and a fourth temperature sensor that are configured to conduct temperature sensing on the feeding zone (4), the extrusion mixing zone (5), the high-temperature melting zone (6), and the extrusion shaping zone (7), respectively;
a controller (17) in signal communication with the first temperature sensor, the second temperature sensor, the third temperature sensor, the fourth temperature sensor, and the motor (1);
a wire control board (13) electrically connected to the first heater (12), the second heater, the third heater, and the fourth heater, wherein the wire control board (13) is in signal communication with the controller (17);
a transformer (14) electrically connected to the wire control board (13);
a water storage container (15), wherein the water storage container (15) is connected to the cooling water inlet through a first pipe (10) and connected to the cooling water outlet through a second pipe (11); the water storage container (15) is further connected with a water supply pipe (9); and the water supply pipe (9) is simultaneously connected to the first water supply branch, the second water supply branch, the third water supply branch, and the fourth water supply branch; and
a rack (18), wherein the extrusion barrel is fixedly arranged on the rack (18).

11. The walnut dreg-derived fibrous tissue protein of claim 3, wherein the sea buckthorn dreg-derived polysaccharide is prepared by a process comprising the following steps:
mixing a powder of the sea buckthorn dreg and water to obtain a mixture, and subjecting the mixture to the water extraction with the assistance of the electrostatic field to obtain a water extract; and
mixing the water extract and an ethanol solution to obtain a mixed solution, subjecting the mixed solution to alcohol precipitation to obtain a reaction system, and subjecting the reaction system to solid-liquid separation to obtain the sea buckthorn dreg-derived polysaccharide;
wherein the electrostatic field has an electric field intensity of 10 kV to 50 kV, a pulse frequency of 10 Hz to 60 Hz, and a pulse time of 20 min to 60 min; and the water extraction is conducted at a material-to-liquid ratio of 1:(2-10) at a temperature of 30° C. to 50° C.

12. The multi-stage temperature-variable extrusion device of claim 9, wherein the paste has a moisture content of 40% to 60%.

13. The multi-stage temperature-variable extrusion device of claim 9, wherein the extrusion mixing is conducted at a temperature of 35° C. to 65° C. and a pressure of 0.2 MPa to 0.45 MPa for 5 min to 10 min;
the high-temperature melting is conducted at a temperature of 80° C. to 100° C. and a pressure of 10 MPa to 40 MPa for 10 min to 20 min;
the extrusion shaping is conducted at a temperature of 105° C. to 155° C. and a pressure of 40 MPa to 50 MPa for 20 min to 30 min; and
the cooling is conducted at a temperature of 40° C. to 50° C. and an atmospheric pressure.

14. The multi-stage temperature-variable extrusion device of claim 9, the method further comprises subjecting a cooled product obtained after the cooling to drying and sterilization in sequence to obtain the walnut dreg-derived fibrous tissue protein;
wherein the drying is conducted at a temperature of 30° C. to 60° C.; and
the sterilization is conducted by ultraviolet sterilization at a power of 30,000 μW/cm² to 35,000 μW/cm².
